(19) United States
(12) Patent Application Publication
(10) Pub. No.: US 2006/0007456 A1
(43) Pub. Date: Jan. 12, 2006

(54) Image signal processing device

(76) Inventor: Takao Ogawa, Suwa (JP)

Correspondence Address: HARNESS, DICKEY & PIERCE, P.L.C., P.O. BOX 828, BLOOMFIELD HILLS, MI, 48303, US

(21) Appl. No.: 11/174,904

(22) Filed: Jul. 5, 2005

(30) Foreign Application Priority Data
Jul. 7, 2004 (JP) 2004-200562

(51) Int. Cl. G06F 15/00

(52) U.S. Cl. 358/1.9

(57) ABSTRACT

An image signal processing device is an image signal processing device that conducts a signal processing of an image signal from an image sensor. The image signal processing device includes a color interpolation circuit that conducts color interpolation of the image signal in unit of pixels from the image sensor, and a data conversion circuit that conducts a prescribed data conversion of the image signal that is color-interpolated by the color interpolation circuit. The data conversion circuit conducts a linear interpolation of digital data, which has a smaller bit count than the digital data of an image signal that is input, based on low-bit data of the digital data.

### RELATED APPLICATIONS

The present application claims priority to Japanese Patent Application No. 2004-200562 filed Jul. 7, 2004 which is hereby expressly incorporated by reference herein in its entirety.

### BACKGROUND

1. Technical Field

The present invention relates to an image signal processing device, particularly to the one having a data conversion circuit.

2. Related Art

It has been common practice for color imaging devices to have an image signal processing device that conducts various kinds of signal processing of image signals captured by image sensors. The image signal processing device converts analog signals received from an image sensor to digital signals, and conducts a prescribed signal processing of the converted digital image signals, so that operations such as display of the captured image in a monitor would be conducted appropriately.

For colored images, a color filter is installed on image sensors. Therefore, the image signal processing device has first conducted a gamma conversion of raw pixel signal data, which is output from the imaging sensor, and subsequently, the data conversion processing of color interpolation has taken place (for example, refer to Japanese Unexamined Patent Publication No. 2002-369034). Moreover, in data conversion processing such as the gamma conversion, etc., the image signal provided with 10 bits, for example, still had 10 bits after the conversion.

In gamma conversion, the characteristics of each color filter are not considered in the conversion processing. More specifically, in case intensity of light received differs for each color due to the characteristics difference between color filters, there is a problem of the error size based on the difference in the light intensity being varied for each color. Therefore, the color interpolation processing, subsequent to the gamma conversion, is conducted on the data that includes the errors of each color that occurred during the gamma conversion. Hence, there has been a problem of the errors of each color, which occurred during the gamma conversion, worsening by the subsequent conversion processing.

Moreover, in case the conversion processing is conducted using table data in gamma conversion etc., the required memory capacity for storing the table data grows if there are many bits per image signal. Therefore, the circuit scale increases, leading to a higher cost of imaging devices. When degradation in image quality can be tolerated, a circuit can be organized in a way to either ignore the last bits of the table data, or round up the most significant bit in the last bits, so that the memory capacity required does not increase. However, in case losing some quality is not tolerated, such a method cannot be employed.

An advantage of the invention is to provide an image signal processing device, wherein the data conversion is conducted without including the errors caused by color difference, and the circuit scale does not increase even if the bit count of an image signal is large.

### SUMMARY

According to an aspect of the invention, an image signal processing device that conducts a signal processing of an image signal from an image sensor includes: a color interpolation circuit that conducts color interpolation of the image signal in unit of pixels from the image sensor; a data conversion circuit that conducts a prescribed data conversion of the image signal that is color-interpolated by the color interpolation circuit; wherein the data conversion circuit conducts a linear interpolation of digital data, which has a smaller bit count than the digital data of an image signal that is input, based on low-bit data of the digital data.

With such a structure, it is possible to implement the image signal processing device, wherein the data conversion is conducted without including the errors caused by color difference, and the circuit scale does not increase even if the bit count of the image signal is large.

It is preferable that the image signal processing device include: a memory chip where table data is stored, having the high-bit data as first input data and output-data that corresponds to the high-bit data; wherein the linear interpolation is conducted to the output data, based on the low-bit data.

With such a structure, the data conversion using the table data can be easily conducted.

It is preferable that the data conversion circuit in the image signal processing device include an input data generation circuit that generates the first input data, and the second input data whereby +1 is added to the first input data. It is also preferable that the data conversion circuit conduct the linear interpolation between two sets of output data, which correspond to two sets of input data generated by the input data generation circuit, based on the low-bit data.

With such a structure, the two sets of output data required for linear interpolation operation can be easily obtained.

It is preferable that the data conversion circuit in the image signal processing device include: a comparator circuit, which compares the two sets of output data, calculates an interpolated value based on the low-bit data, and adds the interpolated value to one of the two sets of output data based on a comparison result of the comparator circuit, where thereby the linear interpolation is conducted.

With such a structure, it is possible to easily determine, to which of the two sets of the output data, the interpolated value calculated based on the last bits, is added.

Moreover, according to the image signal processing device in the invention, it is desirable that the memory circuit be provided with a rewritable storage chip.

With such a structure, the conversion data corresponding to the characteristics of the display devices etc. can be easily determined.

### BRIEF DESCRIPTION OF THE DRAWINGS

FIG. 1 is a block diagram showing the structure of the image signal processing device that relates to the embodiment of the invention.

FIG. 2 is a drawing to show an example pattern of a color filter in the embodiment of the invention.

FIG. 3 is a block circuit diagram showing the structure of the data conversion circuit that relates to the embodiment of the invention.

FIG. 4 is a timing chart showing the read-out and the input timings of signals.

FIG. 5 is a drawing for describing an example of adding the interpolated value to the output data in the linear interpolation circuit.

FIG. 6 is a drawing for describing an example of adding the interpolated value to the output data in the linear interpolation circuit.

FIG. 7 is a drawing for describing another example of adding the interpolated value to the output data in the linear interpolation circuit.

FIG. 8 is a drawing for describing another example of adding the interpolated value to the output data in the linear interpolation circuit.

### DETAILED DESCRIPTION

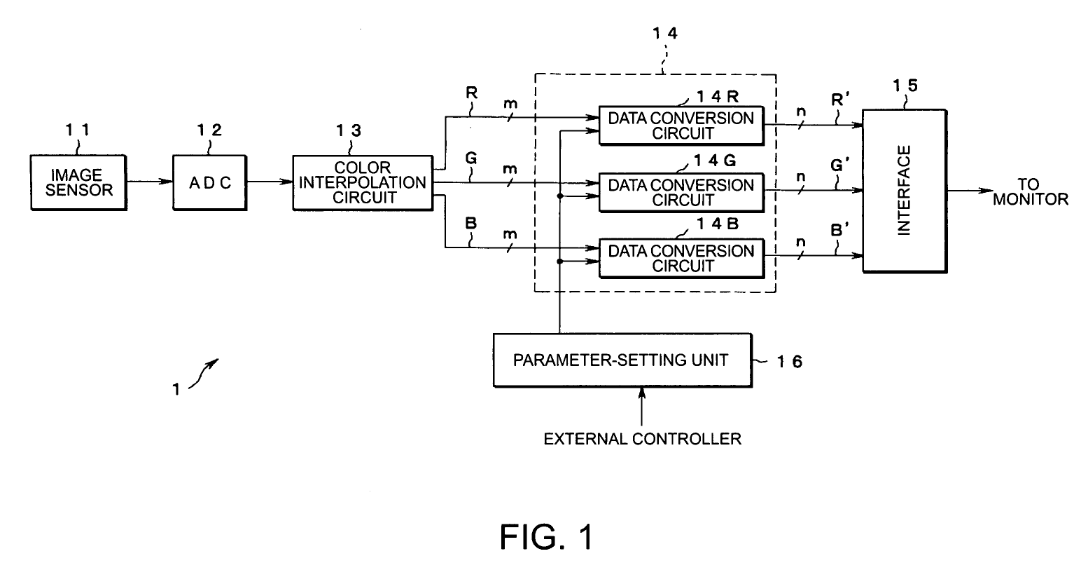

The embodiment of the invention will now be described with reference to the drawings. FIG. 1 is a block diagram showing the structure of the image signal processing device that relates to the embodiment of the invention. The image signal processing device is utilized, for example, in a color imaging device, and conducts signal processing of the image signals from an image sensor. As shown in FIG. 1, an image signal processing device 1 converts the analog image signal of each pixel that underwent the photoelectronic conversion, where the signal is output from a single charge coupled device (hereafter “CCD”) image sensor 11, into the digital signal at the analog-to-digital converter (ADC) 12. The image sensor 11 is provided with a single charge coupled device CCD sensor, or a complementary metal oxide semiconductor image (CMOS) sensor, etc. Color filters for fundamental colors (not shown) are installed in the image sensor 11. The analog image signal for each pixel that is output from the image sensor 11 corresponds to each color.

The output signal of the analog-to-digital converter 12, in other words, the digital image signal of each pixel, is input into a color interpolation circuit 13. The color interpolation circuit 13 generates image data for one output pixel, based on a plurality of, in this case, four pixels of digital image signals. The image data for one output pixel is composed of image signals representing three fundamental colors of RGB (red, green, and blue). The color interpolation circuit 13 outputs three image signals, in this case the RGB image signals, into a data conversion circuit 14. Here, the image signals for each color that are output from the color interpolation circuit 13 have a data length of m bits (where “m” is an integer hereafter). For example, m represents 10, and image signals for each color are 10 bits long.

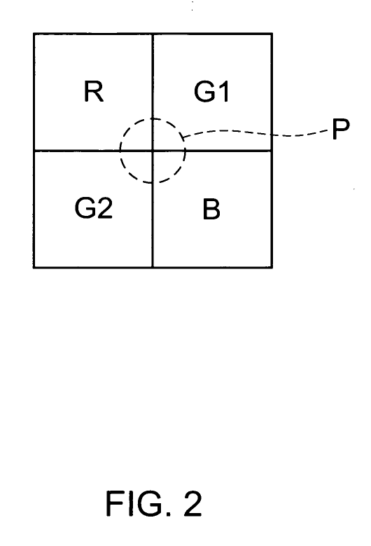

FIG. 2 is a drawing that shows an example pattern of a color filter. The array combination shown in FIG. 2 is installed in the image sensor 11 as a unit of filters, having 4 color filters red (R), green (G1), green (G2) and blue (B) as one unit. The color interpolation circuit 13 generates and outputs three image signals, in other words, RGB signals, that represent one output pixel (P), from four image signals that correspond to four pixels on the image sensor 11. Therefore, with the following relational expressions, those three image signals (for example RGB) for the one output pixel (P), are attained from four image signals of each pixel for one red (R), two greens (G1, G2) and one blue (B) as shown in FIG. 2.
R=R
G=(G1+G2)/2
B=B expression (1)

The data conversion circuit 14 has data conversion circuits 14R, 14G, and 14B that correspond to image signals for each color, so as to conduct data conversion processing of each three image signals. Here, the data conversion circuit used for a data conversion means is a gamma conversion circuit. That is to say, the signal R output from the color interpolation circuit 13 is input into the data conversion circuit 14R. The signal G output from the color interpolation circuit 13 is input into the data conversion circuit 14G. The signal B output from the color interpolation circuit 13 is input into the data conversion circuit 14B. Hence, the color interpolation circuit 13 undertakes the color interpolation of image signals per each pixel from the image sensor 11, and outputs 10-bit image signals for each color.

The color interpolation is conducted on each 10-bit image signal for each color. Subsequently, the gamma conversion is conducted in the data conversion circuit 14, and the signals are output to an output appliance, for example, a monitor, via an interface circuit 15. Here, the converted image data is output into the monitor. However, it may also be output to a conversion circuit that converts the data into other image data formats such as YUV etc., so that image file data is generated.

As shown in FIG. 1, the image signal processing device 1 conducts the data conversion after the color interpolation. On the other hand, if the gamma conversion is conducted first, and the color interpolation is conducted after that, the errors of each color, which occurred during the gamma conversion, are worsened by the subsequent conversion processing, since the intensity of light received varies for each color due to the characteristics difference between color filters. In contrast, as mentioned above, it is possible to conduct gamma conversion without including the errors caused by color difference, by conducting data conversion after the color interpolation.

The data conversion circuits 14R, 14G, and 14B shown in FIG. 1 respectively include rewritable RAM (Random Access Memory). A parameter setting unit 16 is connected to the data conversion circuits 14R, 14G, and 14B, so as to set parameter data used for data conversion. The parameter data can be input and set from the parameter setting unit 16 to data conversion circuits 14R, 14G, and 14B. More specifically, the parameter setting unit 16 may be, for example, a microcomputer and the like, and it provides the parameter data provided from an external computer, for example, a personal computer, to the data conversion circuits 14R, 14G, and 14B respectively. As described, the image signal processing device 1 has individual data conversion circuits for each of the colors that undergo color interpolation, in this case, the RGB colors, and the data conversion is processed for each of the RGB colors.

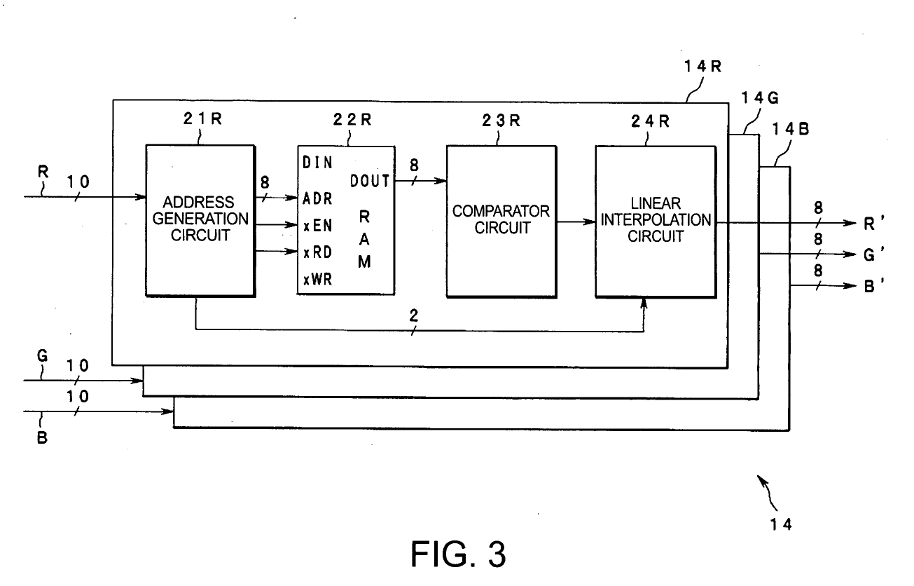

FIG. 3 is a block circuit diagram showing the structure of the data conversion circuit 14. The data conversion circuits 14R, 14G, and 14B in the data conversion circuit 14 include address generation circuits 21R, 21G, and 21B, RAM chips (hereafter, “RAM”) 22R, 22G, and 22B for conducting data conversion, comparator circuits 23R, 23G, and 23B, and linear interpolation circuits 24R, 24G and 24B. RAM 22 is a storage chip that can store digital data, and can be rewritten. Hereafter, three RAMs 22R, 22G and 22B may be comprehensively called RAM 22.

Each of the data conversion circuits 14R, 14G, and 14B in the data conversion circuit 14 substantially has the same structure. Hence, hereafter, the structure of the data conversion circuit 14R will be mainly described, and the description of the structure and the operation for the other two data conversion circuits 14G and 14B will be omitted.

The address generation circuit 21R outputs the first n bits of data (where “n” is an integer hereafter), of the m-bit data that corresponds to the color red (R) from the color interpolation circuit 13, to the RAM 22R. The last 2-bit data is output into the linear interpolation circuit 24R. Here, the value of m is 10, and the value of n is 8. The RAM 22 R is provided with a write-in data input terminal DIN, an address data input terminal ADR, a chip select signal input terminal xEN, a read signal input terminal xRD, a write-in control signal input terminal xWR, and a data output terminal DOUT which the converted signal is output to. As described later, the address generation circuit 21R generates two sets of input data. One is the 8-bit data k, which is the first 8 bits of data in the 10-bit data that is input. The other is the input data (k+1), whose value is larger by +1 than that of the 8-bit data k. The address generation circuit 21R generates these two sets of output data, which enable to easily attain the data necessary for conducting the linear interpolation described later.

Table data for conducting prescribed data conversion of the input image signal is stored in the RAM 22R. More specifically, the table data stores the output data that corresponds to the input data later shown in FIGS. 5 and 7. The digital data, provided from the address generation circuit 21R, which serves as an input data generation means, is input into the RAM 22R, and the corresponding output data is output from the RAM 22R.

Here, the table data is stored in the RAM 22R, wherein the 8 bits of input data and the corresponding 8 bits of output data are arranged as a table of data. In other words, the RAM 22R conducts data conversion, by outputting the 8-bit image signal as output data that corresponds to the 8-bit image data input from the address generation circuit 21R. In the data conversion circuit 14R, the data conversion can be easily conducted since the table data is used for the data conversion. The image signal input into the data conversion circuit 14R is provided with the 10-bit data, while the first 8 bits are converted by the RAM 22R, which is less than the bit count of the image signal's digital data. The conversion precision declines because of those missing last 2 bits. However, as will be described later, the linear interpolation of the RAM 22R's output data is conducted based on the last 2-bit data. As described, the table data is provided with the high-bit data of the image signal, and the output data that corresponds to the high-bit data.

In FIG. 3, the structure of the connection with the parameter-setting unit 16 is omitted. In the case of setting the parameter data to the RAM 22, the table data for each color is provided from the parameter setting unit 16, and the table data is written in to the corresponding RAM22. More specifically, in the case of setting the parameter data that corresponds to the signal R, for example, the chip select signal input terminal xEN of the RAM 22R is turned on, the RAM 22R is selected, and the data of the input image signal for the input signal R, is provided to the address data input terminal ADR. In this status, the output image signal data is provided to the write-in data input terminal DIN, and the write-in control signal input terminal xWR is turned on. As a result, the parameter data, which is composed of the input image signal and the output image signal that corresponds to that input image signal, is stored in the RAM 22R. For example, if the table data is provided with 256 sets of output data that correspond to the 256 sets of input data, 256 pairs of parameter data, composed as a pair of input data and output data, are stored in the RAM 22R.

The comparator circuit 23R receives two 8-bit image signals from the RAM 22R, as will be described later. The comparator circuit 23R compares the size of two the image signals received, and outputs result information that shows the comparison result thereof, as well as the two 8-bit image signals, into the line interpolation circuit 24R.

The linear interpolation circuit 24R conducts a linear interpolation of the two sets of output data that correspond to the two sets of input data, using the two 8-bit image signals and comparison result information from the comparator circuit 23R, and the last 2-bit data from the address generation circuit 21R.

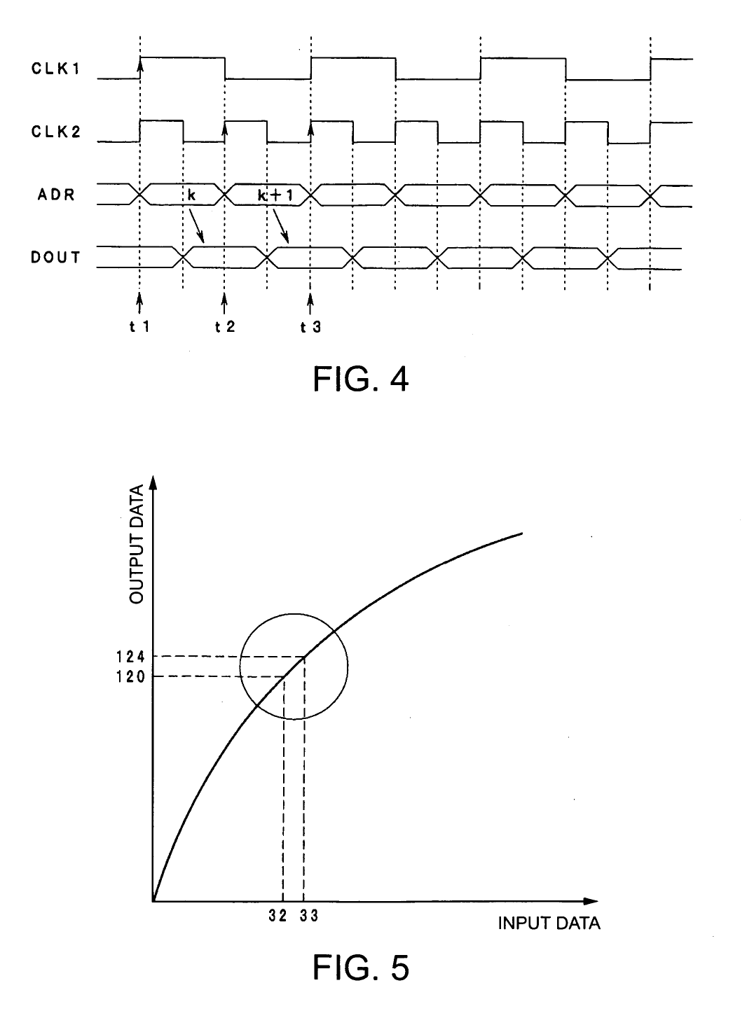

FIG. 4 is a timing chart showing the timings of the signal read-out and the signal input in the RAM 22R, in relation to the address generation circuit 21R in FIG. 3. The data read-out from the RAM 22R is conducted as follows. In the data conversion circuit 14R, if the data conversion is conducted, the chip select signal input terminal xEN in the RAM 22R is turned on, and RAM 22R is selected. In this status, the first 8-bit data k of the input data, and other 8-bit data (k+1) whose value is larger by +1, are input respectively from the address generation circuit 21R into the address data input terminal ADR in the RAM 22R. The read signal input terminal xRD is turned on twice at the time when the clock count is transiting to the timing of a CLK2. As a result, the corresponding two sets of output data are output to the comparator circuit 23R from the data output terminal DOUT in the RAM 22R.

As shown in FIG. 4, the first 8-bit data k of the input data is input into the address data input terminal ADR, at the prescribed timing t1 of the timing clock CLK2 at twice the frequency of a timing clock CLK1. The address generation circuit 21R generates, within itself, the 8-bit data k and the 8-bit data (k+1) whose value is larger by +1 than that of the 8-bit data k, and inputs it to the address data input terminal ADR at the prescribed timing t2 of the timing clock CLK2.

The address generation circuit 21R provides the 8-bit data k that corresponds to the first 8 bits of the 10-bit image signal, and the input data (k+1) whose value is larger by +1 than that of the 8-bit data k, to the RAM 22R. At the same time, the address generation circuit 21R provides the read signal to the RAM 22R twice. The RAM 22R reads out the output data that corresponds to two sets of 8-bit input data k and k+1, and outputs it to the comparator circuit 23R. The comparator circuit 23R, latches the two sets of output data output from the RAM 22R to a register, and compares them. It thus outputs the data that shows the size relations between the two sets of output data, in other words, the comparison result information, to the linear interpolation circuit 24R.

FIG. 5 is a drawing describing the relations between the two sets of input data (8-bit data k and k+1) input into the RAM 22R, and the two sets of output data output from the RAM 22R. For example, if the 10-bit image signal is input into the address generation circuit 21R, the image signal may take 1024 possible values, while in the RAM 22R, 256 sets of table data, that are in accordance with those 8 bits, are stored. The address generation circuit 21R provides the first 8-bit data to the RAM 22R, thus the RAM 22R, having the first 8-bit data as input data, outputs one of 256 possible values of output data, which is less fine than 1024. For example, when “32” is represented by the first 8 bits in the 10-bit input data, the output data that may correspond to “32” is “120”.

The address generation circuit 21 generates input data “33”, whose value is larger by +1 than the input data “32” represented by the upper 8 bits, and provides it to the RAM 22R. Thus the RAM 22R also outputs “124” corresponding to “33”.

The comparator circuit 23R compares the two sets of output data “120” and “124”, and determines that the output data for input data “33” is larger than that of “32”. The linear interpolation circuit 24R calculates the interpolated value for the output data “120”, based on the comparison result information, whereby the larger data is determined, and on the lower 2 bits data. It subsequently adds the interpolated value to the output data. Consequently, the linear interpolation circuit 24R has a circuit that adds the interpolated value to the output data. The data corresponds to the input data (8-bit data k), if, when that input data is increased by +1, the input data (8-bit data k+1) which is increased by +1, is determined to be larger than the input data (8-bit data k).

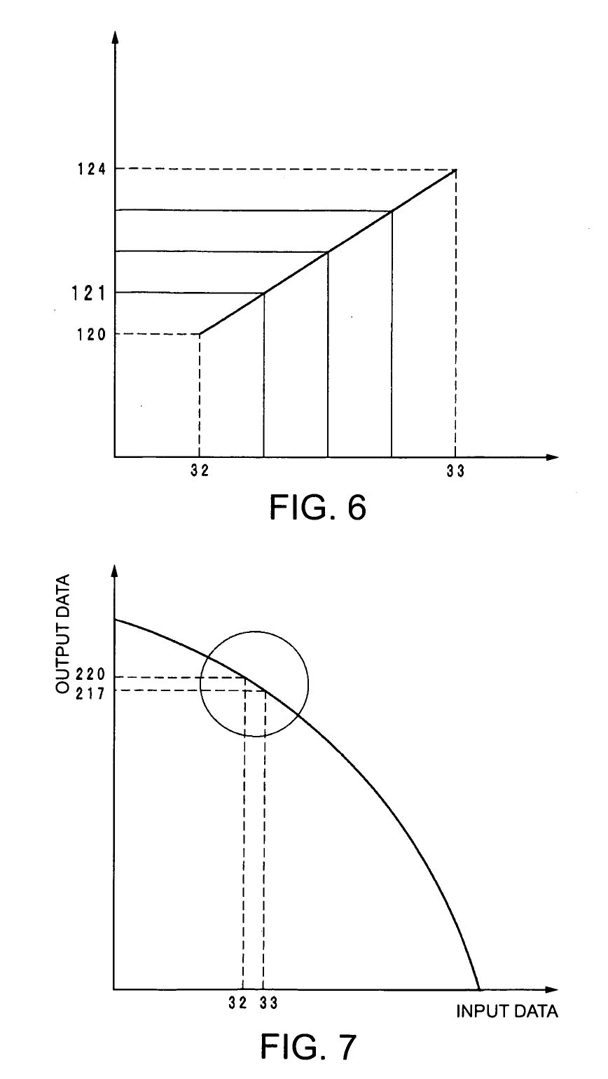

FIG. 6 is a drawing for describing the method of interpolation processing with the linear interpolation circuit 24R. In FIG. 6, the output data “120” and “124” corresponding the input data “32” and “33” is stored as table data in the RAM 22R. With the last 2-bit data, the two 8-bit output data points are interpolated. With the last 2 bits, the two data points for output data “120” and “124” undergo linear interpolation. In this case, there are three possible output data values; “120+(124−120)*¼”, “120+(124−120)* 2/4”, and “120+(124−120)*¾”.

If the last 2 bits are “00”, then the interpolated value is “0”. If the last 2 bits are “01”, then the interpolated value is “(124−120)*¼”, if the last 2 bits are “10”, then the interpolated value is “(124−120)* 2/4”, and if the last 2 bits are “11”, then the interpolated value is “(124−120)*¾”. As described, the linear interpolation circuit 24R calculates the interpolated value based on the last 2 bits of data, adds that interpolated value to the output data “120”, and performs interpolation so that the output data becomes smooth. An 8-bit linear interpolated red image signal (R′) is output from the linear interpolation circuit 24R.

As shown in FIGS. 5 and 6, if the linear interpolation circuit 24R obtains the comparison result information from the comparator circuit 23R, indicating that the output data for the input data “33” whose value is larger by +1 than the input data “32”, is larger than that of the input data “32”, then the linear interpolation circuit 24R adds the interpolated value, calculated based on the last 2 bits of data, to the output data “120”.

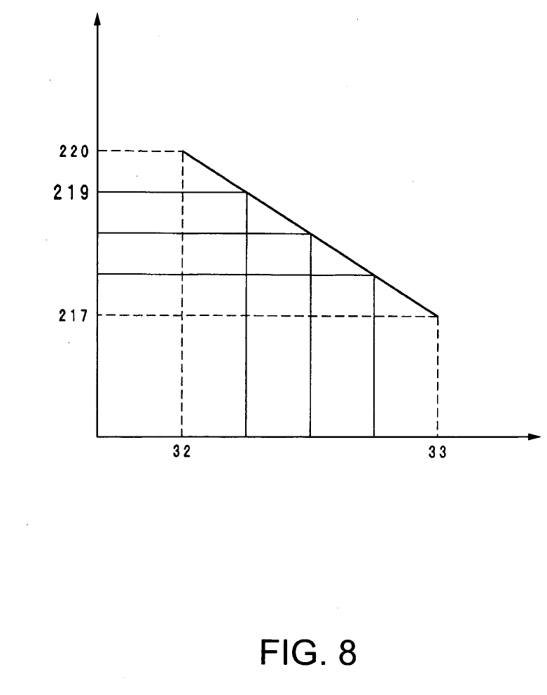

FIGS. 7 and 8 are drawings for describing another example. If the linear interpolation circuit 24R obtains the comparison result information from the comparator circuit 23R, indicating that the output data of the input data “33” whose value is larger by +1 than the input data “32”, is smaller than that of the input data “32”, then the linear interpolation circuit 24R adds the interpolated value calculated based on the last 2-bit data, to the output data “217”.

As shown in FIG. 7, the output data “220” and “217” corresponding to the input data “32” and “33” is stored as table data in the RAM 22R. The linear interpolation circuit 24R calculates the interpolated value based on the last 2-bit data, adds that interpolated value to the output data “217”, and performs interpolation so that the output data becomes smooth. With the lower 2 bits, the two data points for output data “220” and “217” undergo linear interpolation. In this case, there are three possible output data values; “217+(220−217)*¾”, “217+(220−217)* 2/4”, and “217+(220−217)*¾”.

If the last 2 bits are “11” then the interpolated value is “0”. If the last 2 bits are “01”, then the interpolated value is “(220−217)*¾”, if the last 2 bits are “10”, then the interpolated value is “(220−217)* 2/4”, and if the last 2 bits are “11”, then the interpolated value is “(220−217)*¼”. As described, the linear interpolation circuit 24R calculates the interpolated value based on the last 2 bits of data, adds that interpolated value to the output data “217”, and performs interpolation so that the output data becomes smooth.

If the interpolated value, attained by dividing the two data points to 2 sets of 8-bit output data, is not an integer but a decimal, then the linear interpolation circuit 24R rounds it off to a whole number. For example, the linear interpolation circuit 24R processes the value for “217+((220−217)*¾)+219.125” to “219”.

As described above, based on the comparison result information of the comparator circuit 23R, it is determined to which of the two sets of output data the interpolated value is added, and the interpolated value is added to one of the two. Consequently, if the parameter is set with a negative slope as shown in FIG. 7, the two 8-bit output data points are interpolated appropriately so as to become smooth.

As described, in the case of attaining 8 bits of converted image signal out of the 10-bit image signal, 10 bit*1024 words (10 k bits) of memory capacity was conventionally necessary, while in the embodiment, 8 bits*256 words (2 k bits) memory capacity is sufficient. Therefore, the circuit scale is decreased and the cost can be reduced. In comparison to the conventional case where only the upper 8 bits are used, the embodiment enables to attain the smooth converted image, thus the image quality is retained when displayed, for example, on the display device.

Consequently, with the image signal processing device in the embodiment, it is possible to implement the image signal processing device that does not enlarge the circuit scale, even if the bit count of image signal is large.

In the above description, the color interpolation method is explained using RGB color interpolation. However, in the invention, the color interpolation for complementary colors (Cy, Mg, Y) may also be employed.

Moreover, in the above description, the gamma conversion is used for the data conversion processing subsequent to the color interpolation. However, the data conversion processing that requires individual adjustments, such as lens shading correction or correction of chromatic aberration, may also be employed.

Still further, in the above, RAM is used in the example as a rewritable storage chip, while the flash ROM etc. may also be employed.

The invention shall not be limited to the above-mentioned embodiment, and it is intended that within the main scope of the invention, various other kinds of modifications and alternation etc., is possible.

What is claimed is:

1. An image signal processing device that conducts a signal processing of an image signal from an image sensor, the image signal processing device comprising:
a color interpolation circuit that conducts color interpolation of the image signal in unit of pixels from the image sensor;
a data conversion circuit that conducts a prescribed data conversion of the image signal that is color-interpolated by the color interpolation circuit;
wherein the data conversion circuit conducts a linear interpolation of digital data, which has a smaller bit count than the digital data of an image signal that is input, based on low-bit data of the digital data.

2. The image signal processing device according to claim 1, comprising:
a memory chip wherein table data is stored, having the high-bit data as first input data and output-data that corresponds to the high-bit data;
wherein the linear interpolation is conducted to the output data, based on the low-bit data.

3. The image signal processing device according to claim 2, wherein the data conversion circuit includes an input data generation circuit that generates the first input data and second input data whereby +1 is added to the first input data, and conducts the linear interpolation between two sets of output data, which correspond to two sets of input data generated by the input data generation circuit, based on the low-bit data.

4. The image signal processing device according to claim 3, wherein the data conversion circuit includes a comparator circuit, which compares the two sets of output data, calculates an interpolated value based on the low-bit data, and adds the interpolated value to one of the two sets of output data based on a comparison result of the comparator circuit, where thereby the linear interpolation is conducted.

5. The image signal processing device, according to claim 1, wherein the memory chip is a rewritable storage chip.
